(19) United States
(12) Patent Application Publication
(10) Pub. No.: US 2013/0266078 A1
(43) Pub. Date: Oct. 10, 2013

(54) METHOD AND DEVICE FOR CORRELATION CHANNEL ESTIMATION

(71) Applicants: Nikolaos Deligiannis, Brussel (BE); Adrian Munteanu, Brussel (BE); Joeri Barbarien, Putte (BE)

(72) Inventors: Nikolaos Deligiannis, Brussel (BE); Adrian Munteanu, Brussel (BE); Joeri Barbarien, Putte (BE)

(73) Assignee: VRIJE UNIVERSITEIT BRUSSEL, Brussel (BE)

(21) Appl. No.: 13/991,361

(22) PCT Filed: Nov. 29, 2011
(86) PCT No.: PCT/EP11/71296

§ 371 Date: Jun. 3, 2013

Related U.S. Application Data
(60) Provisional application No. 61/418,518, filed on Dec. 1, 2010.

(51) Int. Cl. H04N 7/26

(52) U.S. Cl. CPC H04N 19/00533
USPC 375/240.25

(57) ABSTRACT

A hash-based distributed video coding architecture has an encoder with an input video sequence organized in Groups of Pictures (GOPs) decomposed into key frames using H264/AVC Intra frame coding. The Wyner-Ziv (WZ) frames are encoded in two parts, a hash layer and a WZ layer. The WZ frames are quantized and each and then decorrelated using spatio-temporal prediction and entropy coded. The intra bit stream is H264/AVC decoded and the intra frames are stored in a reference frame buffer. The hash is decoded by inverting the tasks applied at the encoder, and the obtained bit planes are stored. Overlapped Block Motion Estimation and Probalistic Compensation (OBMEPC) is used to estimate the missing bit planes in the side-information. The decoder utilizes the hash information and the side information frame created by OBMEPC to perform online estimation of the correlation channel, and produces soft estimates used to decode the WZ bit planes.

### FIELD OF THE INVENTION

The present invention generally relates to encoding and decoding schemes, in particular for video applications, wherein an estimation is performed of a correlation channel expressing the correlation between a signal, referred to as side-information, available to a decoder and a correlated signal not available at the decoder.

### BACKGROUND OF THE INVENTION

Uplink-oriented, power-constrained applications, e.g., wireless multimedia sensors, have required the design of novel video coding architectures, providing low-cost encoding, robustness against transmission errors and high compression efficiency. Uplink-oriented applications are involved in uplink transmission from a low complex terminal to a network base station or a terminal with notably higher power processing capability. Potential solutions to satisfy these austere requirements move towards a paradigm commonly referred to as distributed source coding (DSC), which is rooted in fundamental information theoretic grounds. In their pioneering work (“Noiseless coding of correlated information sources”, IEEE Tr. Information Theory, vol. 19, no. 4, pp. 471-480, July 1973) Slepian and Wolf proved that the rate needed to compress two correlated sources noiselessly is the same, whether the correlation is exploited at the encoder or at the decoder. Wyner and Ziv have extended these findings to lossy coding with side-information (SI) available at the decoder. They showed that, for a given distortion level, the rate needed to encode a source when the SI is perfectly known only at the decoder is larger or equal to the rate needed when the SI is known at both encoder and decoder sides. Equality holds for jointly Gaussian memoryless sources and a mean square error distortion measure. With side-information is meant a signal or source of information which is statistically correlated with a signal X which is to be coded. For instance, in the context of sensor networks, side-information may represent archived data or readings from sensors localized at the central unit (that is, the decoder). At each individual sensor of the network (namely the distributed encoders), the observations of the other sensors nor the side information is available (see for example D. Rebollo-Monedero, “Quantization and transforms for distributed source coding,” Ph.D. dissertation, Stanford University, 2007).

Triggered by DSC theory, distributed video coding (DVC) became a new coding paradigm supporting the aforesaid demands in video coding. By exploiting the inherent correlation present in the video sequence at the decoder, DVC architectures allow for a complexity shift from the encoder to the decoder, in contrast to conventional video coding. Since good DSC code constructions are based on channel coding concepts, distributed joint-source channel coding of video provides robustness against transmission errors. In addition, layered Wyner-Ziv (WZ) coding enables scalable video coding. Furthermore, DSC theory facilitates efficient multi-view video coding without requiring inter-camera communication. Lately, DSC principles found application in flexible video decoding and flexible distribution of complexity.

In the context of low-cost distributed video compression, a feedback channel-based Wyner-Ziv architecture has been proposed, initially operating in the pixel-domain and later on in the transform-domain. At the outset, motion compensated interpolation (MCI) or extrapolation (MCE) were employed to generate the SI at the decoder. An improved MCI technique, employing bidirectional motion estimation and compensation followed by spatial smoothing was later incorporated in the DISCOVER codec (see X. Artigas et al., “The DISCOVER codec: Architecture, techniques and evaluation,” Picture Coding Symposium, PCS 2007, Lisbon, November 2007), providing state-of-the-art coding performance. Although MCI performs fine in sequences with slow and regular motion, it still fails to capture high and irregular motion characteristics mainly due to blind motion estimation. To overcome this problem, effective side-information creation approaches are based on successive refinement of the side-information or on hash-based motion estimation. In this direction, some prior art solutions utilize trellis syndrome and cyclic redundancy codes to exploit temporal dependency at the decoder. However, as repeated decoding operations are performed using every candidate block in the previous frame, the decoding complexity is severely increased. In successively refined motion estimation, the decoder upgrades the quality of the SI when additional information is decoded. This strategy can be seen as joint decoding and motion estimation. Alternative schemes propose the transmission of auxiliary (hash) information to the decoder in order to augment SI generation. In this context, the inventors of the present invention have proposed overlapped block motion estimation and probabilistic compensation (OBMEPC) (see e.g. application WO2009/62979), which enables accurate capturing of motion using a coarse version of the original frame.

Although in distributed source coding (DSC) theory the decoder is assumed to have perfect knowledge of the correlation statistics, in a practical DVC system this is not the case, since the current frame is available only at the encoder and the SI is produced only at the decoder. That is, the correlation channel noise can never be directly measured in a practical DVC system. To solve this problem, accurate correlation channel modelling is needed. Existing approaches construct an additive correlation channel model in which the noise is assumed to be independent of the channel input signal. In early works, a zero-mean Laplacian noise model is employed, of which the scaling parameter is assumed temporally- and spatially-stationary. Later, Westerlaken et al. argued in The role of the virtual channel in distributed source coding of video” (IEEE Int'l Conf. Image Processing, Genova, September 2005) that by differentiating the noise scaling parameter for occluded and non-occluded areas the overall coding performance is improved. Nevertheless, later they also showed that segmentation inaccuracies notably reduce the convenience of the non-stationary model. In the state-of-the-art MCI-based DVC architecture, a spatially-stationary Laplacian model was proposed wherein online estimation is performed of its scaling parameter per WZ frame/DCT band at the decoder side. Since the quality of the SI fluctuates spatially, also a block and pixel/DCT coefficient based estimation was proposed in order to offer improved adaptation to the varying spatial statistics. However, adaptation in smaller spatial regions does not necessarily lead to improved performance, since online estimation becomes imprecise due to limited statistical support information. To improve the estimation progressive refinement of the noise variance upon decoding of each DCT band has been proposed.

In contrast to earlier models, an additive correlation channel model, X=Y+N, in which the noise N depends on the channel input signal, was introduced (e.g. in On the side-information dependency of the temporal correlation in Wyner-Ziv video coding,” N. Deligiannis et al., IEEE Int'l Conf. on Acoustics, Speech, and Signal Processing, Taipei, April 2009). Since the SI signal is the input of the considered channel, the term side-information dependent (SID) correlation noise model is used. In particular, the concept of SID modelling was introduced in the pixel-domain and validated experimentally using a fitting error metric (i.e., conditional relative entropy), minimized offline. Optimal side information SI by means of a motion oracle was assumed in one approach, alternatively SI was generated using OBMEPC. The improvement in fitting accuracy, brought by SID modelling, was shown to imply rate savings.

In DSC, the correlation is often expressed by an additive noise channel model, X=Y+N, where the SI Y is the input and the source X the output of the channel and N denotes the noise. Hence, by definition, the relation between the conditional probability density function (PDF) of the channel between the conditional probability density function (PDF) of the channel output and the conditional PDF of the noise, given the input, is expressed as

f_{X|Y}(x|y)=f_{X-Y|Y}(x−y|y)=f_{N|Y}(n|y) (1)

Assuming that the correlation noise is independent of the channel input signal, i.e., N is independent of Y in the considered channel model, the correlation channel model is simplified to

f_{X|Y}(x|y)=f_{N/Y}(n|y)=f_{N}(n). (2)

The prior art solutions however suffer from the drawback that they are solely created for MCI-based systems. Further they are not capable of capturing the dependency of the correlation noise on the side information. Transform-domain correlation estimation methods have the additional limitation that they refine the side information independent model parameters across DCT bands of a WZ frame and do not allow for a smaller granularity. Furthermore there is also a need for an approach that is not limited to video only, but that is applicable to general sources, including images, sound, measurement data, etc. . . . .

### SUMMARY OF THE INVENTION

It is an object of embodiments of the present invention to provide a method and decoder device for performing correlation channel estimation wherein the above-mentioned drawbacks are overcome and wherein a successively refined correlation channel estimation is obtained.

The above objective is accomplished by a method and device according to the present invention.

Particular and preferred aspects of the invention are set out in the accompanying independent and dependent claims. Features from the dependent claims may be combined with features of the independent claims and with features of other dependent claims as appropriate and not merely as explicitly set out in the claims.

In a first aspect the invention relates to a method for estimating at a decoder statistical correlation between a first signal available to the decoder and a second signal correlated with the first signal, said second signal being encoded by an encoder and unavailable at the decoder. The first and the second signal each are represented by a plurality of bit planes. The method comprises the steps of
deriving an estimate of the statistical correlation based on the first signal and at least one previously decoded bit plane of said second signal, and
performing decoding of a subsequent bit plane of the second signal based on the estimate obtained in the previous step.
   The first signal comprises side-information on the second signal, said second signal being an encoded source signal available only at the encoder side.
   The method according to the invention proposes to derive an estimate of the correlation channel based on the first signal and already decoded bit planes of the second signal and then to use that estimate for decoding a following bit plane. By iteratively decoding the various bit planes and performing a correlation channel estimation based on the bit planes that already have been decoded, a successive refinement of the correlation channel estimation is achieved.

Hence, as already mentioned, the method is most preferably performed in an iterative way.

In an embodiment of the invention the method comprises a step of reconstructing the second signal at the decoder side. This step is preferably performed after all bit planes of the second signal have been decoded. An estimate of the statistical correlation can then be derived exploiting all the decoded bit planes of the second signal, which can next advantageously be used in the reconstruction of the second signal.

To initiate the above-described method various options are open. In one advantageous embodiment the first bit plane is made available at the decoder by performing a step of transmitting to said decoder a losslessly compressed first bit plane of the second signal. Alternatively, the first decoded bit plane of the second signal is derived from an initial estimate based on a previously decoded block of data.

In one embodiment the dissimilarity between the first signal and the second signal is caused by communication channel errors and/or prediction errors.

In a preferred embodiment the statistical properties of the first signal and the second signal vary per block of samples. The proposed method is capable of providing an accurate correlation channel estimate for a given stationarity level of the correlation noise signal.

In one embodiment the statistical correlation is represented by an additive noise channel model X=Y+N, whereby Y denotes the first signal, X the second signal and N a channel noise signal. In a preferred embodiment the channel noise signal is statistically dependent on the first signal.

In a preferred embodiment the first and the second signal represent samples of video.

In another aspect the invention relates to a decoder adapted for estimating statistical correlation between a first signal available at the decoder and a second signal, said second signal being correlated with the first signal and unavailable at the decoder, whereby the first and the second signal are each represented by a plurality of bit planes. The decoder comprises processing means arranged for deriving an estimate of the statistical correlation based on the first signal and on at least one previously decoded bit plane of the second signal. The decoder is further arranged for decoding a subsequent bit plane of the second signal based on the estimate derived by the processing means.

For purposes of summarizing the invention and the advantages achieved over the prior art, certain objects and advantages of the invention have been described herein above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

The above and other aspects of the invention will be apparent from and elucidated with reference to the embodiment(s) described hereinafter.

### BRIEF DESCRIPTION OF THE DRAWINGS

The invention will now be described further, by way of example, with reference to the accompanying drawings, in which:

FIG. 1 represents a schematic representation of the additive, memoryless a) side-information independent and b) the considered side-information-dependent Generalized Gaussian correlation channel.

FIG. 2 represents the projection of the (a) SII and (b) SID Laplacian or Gaussian correlation channel distribution mode for an assumed stationarity level.

FIG. 3 represents a block diagram of the rate-adaptive Wyner-Ziv coding scheme. Continuous lines represent the coding part while dashed and dotted lines signify the correlation channel statistics.

FIG. 4 represents a block diagram of the proposed pixel-domain hash-based DVC architecture.

FIG. 5 represents a block diagram of the proposed transform-domain hash-based DVC architecture.

FIG. 6 represents an example of a spatio-temporal prediction scheme.

FIG. 7 represents a block diagram of another proposed hash-based DVC scheme according to the invention.

FIG. 8 represents an overview of the hash formation and spatial prediction processes. On the left, gray circles with solid lines denote the sub-sampled original pixel values. On the right, dashed circles signify the MSB of the sub-sampled pixel values.

FIG. 9 depicts the compression performance comparison of correlation estimation methods for (a) Carphone, GOP4, and (b) Soccer, GOP2.

FIG. 10 depicts the compression performance evaluation of the hash-based DVC codec of FIG. 7 (equipped with the invention) for (a) Foreman QCIF, 15 Hz, GOP8 and (b) Silent QCIF, 15 Hz, GOP8 sequences.

FIG. 11 depicts the compression performance evaluation of the hash-based DVC codec for capsule endoscopy (equipped with the invention) for two test endoscopic video sequences.

The drawings are only schematic and are non-limiting. In the drawings, the size of some of the elements may be exaggerated and not drawn on scale for illustrative purposes.

Any reference signs in the claims shall not be construed as limiting the scope.

In the different drawings, the same reference signs refer to the same or analogous elements.

### DETAILED DESCRIPTION OF ILLUSTRATIVE EMBODIMENTS

The present invention will be described with respect to particular embodiments and with reference to certain drawings but the invention is not limited thereto but only by the claims.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

It should be noted that the use of particular terminology when describing certain features or aspects of the invention should not be taken to imply that the terminology is being re-defined herein to be restricted to include any specific characteristics of the features or aspects of the invention with which that terminology is associated.

In the description provided herein, numerous specific details are set forth. However, it is understood that embodiments of the invention may be practiced without these specific details. In other instances, well-known methods, structures and techniques have not been shown in detail in order not to obscure an understanding of this description.

A generic framework is first described for online, progressively refined, side-information dependent correlation channel estimation in rate-adaptive, layered Wyner-Ziv coding. The followed approach builds on the realistic and accurate consideration of an additive Generalized Gaussian correlation noise which is dependent on the realization of the side-information. Concerning notations, capital italic letters are employed to denote random variables, e.g., X, and small italic letters, e.g., x, for their realizations or samples. The alphabet of a random variable is denoted by the capital letter A_{X} adding a subscript index referring to the random variable. Furthermore, the understaffed notation xᵢ^{N} is used to note the i^{th} N-tuple of realizations xᵢ⁰, xᵢ¹, . . . , xᵢⁿ, . . . , xᵢ^{N-2}, xᵢ^{N-1}.

DSC designs express the correlation between the source X and the side information Y in terms of an additive, memoryless, noise component, i.e., X=Y+N, which is considered to be independent of the side-information. Although Y (and hence X) can be arbitrarily distributed, in traditional DSC works, N is considered to follow well-known statistical distributions, namely the Gaussian or the Laplacian. Real-life data though, indicate that the distribution of the correlation noise follows more generic probability density functions (PDF) and more importantly, its dependency on the realization of the side-information cannot be omitted.

In the proposed model the side-information is considered to be arbitrarily distributed with a finite alphabet. Furthermore, the correlation channel between the source X and the side-information Y is expressed in terms of an additive, memoryless noise component affecting the realizations yεA_{Y} of the side-information. To broaden the applicability of the proposed channel estimation framework, the Generalized Gaussian PDF is employed to model the distribution of the correlation noise.

Conventional DSC schemes assume the additive, memoryless correlation noise component to be independent of the realization of the side-information—see FIG. 1(a), in this case, the PDF of the side-information independent (SII) Generalized Gaussian correlation channel is:

$${f}_{X \vert Y} ( x \vert y ) = \frac{η α}{2 Γ ( 1 / α )} {e}^{- {[ η \vert x - y \vert ]}^{α}} \qquad ( 3 )$$

where, η=\sqrt{Γ(3/α)/Γ(1/α)}/σ, α is the shape parameter, σ is the standard deviation (sigma) of the Generalized Gaussian PDF, and Γ(s)=∫₀^{∞}t^{s-1}e^{-t}dt is the gamma function.

In the proposed model on the contrary the correlation noise N is assumed to be statistically dependent on the side-information Y. The schematic depiction of the proposed side-information dependent (SID) correlation channel is illustrated in FIG. 1(b). The dependency between the noise and the side-information, highlighted with the transition probability p(n|y), causes the noise parameters to vary based on the realization yεA_{Y} of the side-information.

In essence, the SID correlation noise fulfilling the above assumptions is given by the following PDF:

$${f}_{X \vert Y} ( x \vert y ) = \frac{η ( y ) α ( y )}{2 Γ ( 1 / α ( y ) )} {{e}^{- [ η ( y ) \vert x - y \vert ]}}^{α ( y )} , \qquad ( 4 )$$

where η(y)={square root over (Γ(3/α(y))/Γ(1/α(y)))}/σ(y), α(y) is the shape parameter function and σ(y) is the standard deviation (sigma) function.

In contrast to (3), the noise dependency on the side-information is expressed in (4) by denoting the shape and standard deviation parameters of the Generalized Gaussian distribution as α(y), σ(y), respectively. The latter implies that the exponential rate of decay and the standard deviation of the correlation noise distribution vary with respect to the realization of the side-information. To avoid loss of generality, the functions α(y), σ(y) are not deterministic and not necessarily one-to-one. If α(y)=α,∀yεA_{Y}, then the dependency of the noise on the side-information is expressed only with the standard deviation parameter, i.e. the function σ(y). For instance, in case α(y)=2,∀yεA_{Y}, Eq. (4) yields the side-information dependent Gaussian correlation noise. Alternatively, if α(y)=1, ∀yεA_{Y}, then Eq. (4) describes the SID Laplacian PDF which is shown to model accurately the correlation channel in Wyner-Ziv video coding.

Most DVC modelling approaches assume the correlation noise as independent zero-mean Laplacian with standard deviation σ, i.e., N˜ [symbol] (0,σ),

$${f}_{N} ( n ) = \frac{1}{σ \sqrt{2}} {e}^{- \frac{\sqrt{2} \vert n \vert}{σ}} . \qquad ( 5 )$$

Therefore, the PDF of the source, X, given the SI Y, is expressed by a Laplacian distribution centred on y having standard-deviation σ, i.e., f_{X|Y}(x|y)=e^{-\sqrt{2}|x-y|/σ}/σ\sqrt{2}.

The independent noise component of (5) has been considered stationary at different levels. In pixel-domain systems, the noise σ parameter is estimated at sequence-level, frame-level, block-level or pixel-level. Analogously, in transform-domain systems, the noise σ parameter is estimated per band of the sequence, per band of each WZ frame (band-level) or per DCT coefficient (coefficient-level). Since in the referred cases, the noise N is independent of the channel input, i.e., the side information Y—see FIG. 1(a) for the schema of the channel, such modelling approaches are called side-information-independent (SII) noise modelling.

Contrary to the SII approach, a different correlation channel modelling concept has been proposed, in which the noise distribution depends on the channel input signal, that is, the SI. Specifically the side-information-dependent (SID) channel model, see FIG. 1(b), assumes the noise as being zero-mean Laplacian with standard-deviation 6(y), which varies depending on the realization y of the SI (input of the channel), that is, N˜ [symbol] (0,σ(y))

$${f}_{{ }_{N \vert Y}} ( n \vert y ) = \frac{1}{σ ( y ) \sqrt{2}} {e}^{- \frac{\sqrt{2} \vert n \vert}{σ ( y )}} . \qquad ( 6 )$$

Since the correlation noise is additive, Eq. (6) implies that for every realization y of the SI alphabet A_{y} the PDF of the channel output, X, is given by a Laplacian distribution centred on y, having a standard-deviation σ(y) which varies with y, i.e., f_{X|Y}(x|y)=e^{-√}\sqrt{2}|x−y|/σ(y)/σ(y)\sqrt{2}.

A validation of this SID channel model in the pixel-domain has been given e.g. in the above-mentioned paper by Deligiannis et al. The SID model accurately captures the empirical conditional probability mass function (PMF), i.e., P_{X|Y}(x|y) ∀yεA_{y}, calculated based on the sample values of a WZ frame X and its SI Y at a given spatial stationarity level. In effect, it has been shown that, compared to the SII model, the SID model brings a vast reduction of the fitting mismatch for a large set of video sequences. The reported improvements are consistent irrespective of the quality of the SI. Particularly, an optimal motion oracle and OBMEPC have been employed. Furthermore, the SID is more accurate than the SII model for various levels of assumed noise stationarity, including frame-level and block-level.

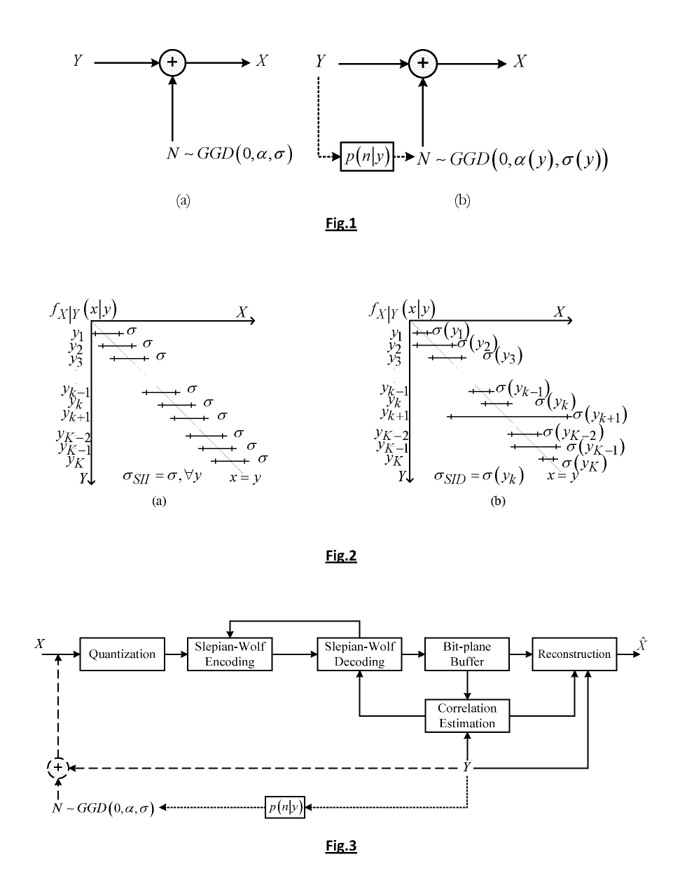

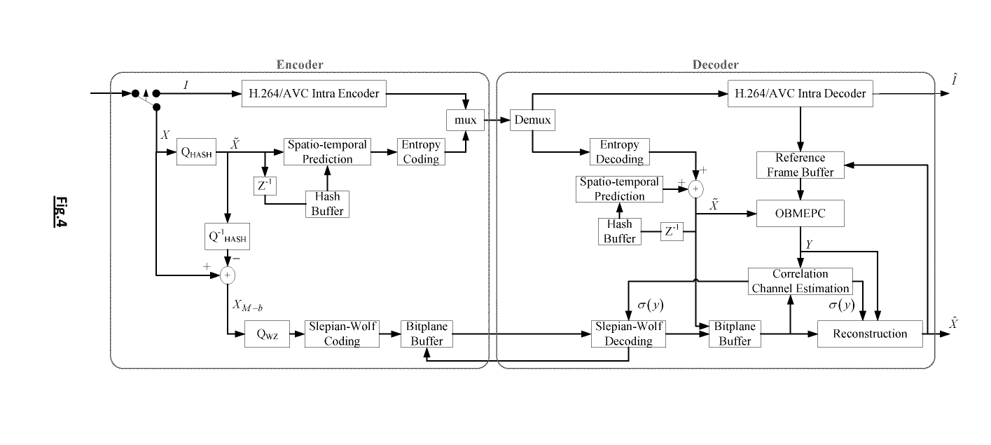

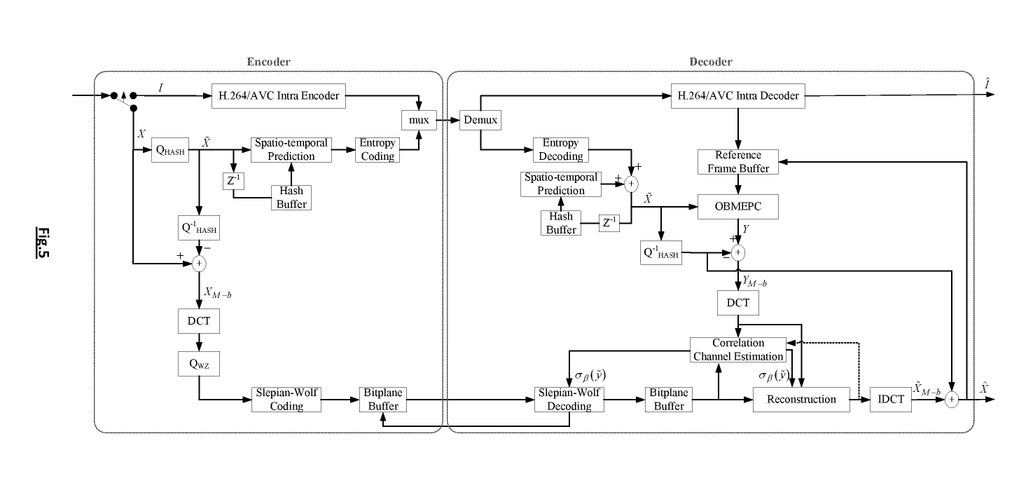

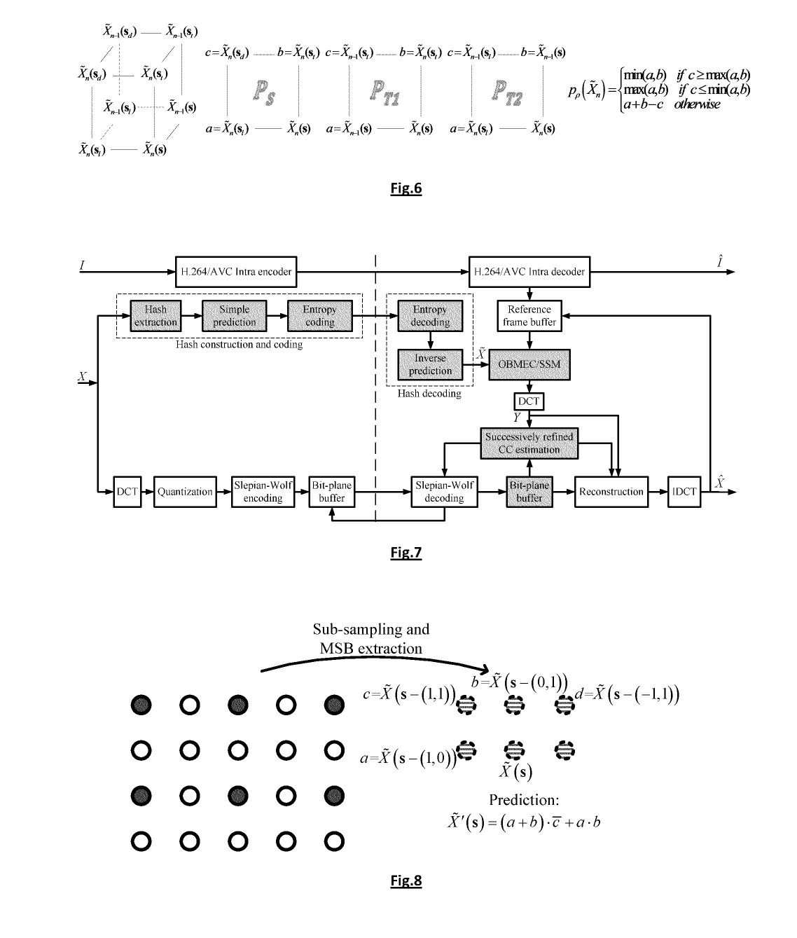

A graphical representation of the SII and SID Laplacian models, for an assumed noise stationarity level, is given in FIG. 2. Let the SI values stem from a discrete alphabet A_{y} with K elements. Then, the projections of the SII and SID Laplacian correlation channel PDFs onto the (X,Y)-plane are given in FIG. 2(a) and FIG. 2(b), respectively. For an assumed noise stationarity level, in the SII (or input-independent) model the noise variance is constant and independent of the SI—see FIG. 2(a). In contrast, in the SID (or input-dependent) model, the noise variance depends on the realization of the SI—see FIG. 2(b). Following the terminology of channel symmetry as adopted by Cover and Thomas in Elements of Information Theory (edited by Wiley, 1991), the SII model can be interpreted as a K-ary input, continuous output symmetric Laplacian channel. Conversely, the SID model is equivalent to a K-ary input, continuous output asymmetric Laplacian channel. In case both X and Y have a binary alphabet, the SII and SID channel models come down to the binary symmetric channel (BSC) and the binary asymmetric channel (BAC) models, correspondingly.

It can be proven that, at the same noise stationarity level, SID channel modelling yields compression gains over classical SII modelling. Driven by this finding, a novel online SID estimation method is proposed which considers band-level SID noise stationarity. The proposed algorithm enables bit plane-by-bit plane successively refined SID correlation estimation, yielding significant gains over the offline SII band-level methods and the online SII coefficient-level techniques.

A WZ scheme is considered with uniform scalar quantization followed by ideal Slepian-Wolf (SW) coding. This scheme has been shown to deliver WZ coding performance equivalent to entropy-coded scalar quantization (ECSQ) in non-distributed coding. To simplify the calculations, known asymptotic results are employed when necessary. The following holds.

Lemma 1: The L-2 distortion for a Laplacian source quantized using a uniform scalar quantizer centered on its mean is given by:

$$D = \frac{2}{{λ}^{2}} - \frac{2 {Δe}^{- λΔ / 2}}{λ ( 1 - {e}^{- λΔ} )} , \qquad ( 7 )$$

where Δ is the cell size of the quantizer, λ=\sqrt{2}/σ, and σ is the standard deviation.
According to high rate results for distributed quantization, the optimal SW-coded scalar quantizer for smooth probability density functions (PDFs) is the uniform quantizer. Based on Lemma 1, the following is derived.
Lemma 2: Let D_{SID}(y), D_{SII} be the distortions of the SID and SII models, respectively, of the form given by (7). If the average SID distortion is equal to the SII distortion, that is, if E[D_{SID}(y)]=∫_{-∞}^{+∞}D_{SID}(y)f_{Y}(y)dy=D_{SII}, for any Δ, then a necessary condition is

∫_{-∞}^{+∞}σ_{SID}²(y)f_{Y}(y)dy=σ_{SII}², (8)

where, σ_{SID}(y), σ_{SII} are the standard-deviations of the SID and SII models respectively, and f_{Y}(y) is the PDF of the side-information Y. It is noted that the employed uniform scalar quantizer is centred on the mean of each Laplacian distribution in order to achieve the upper bound in the WZ source coding gain. Based on these two lemmas it can be proven that assuming an SII correlation channel results in a system loss. The following holds
Theorem 1: Under high rate assumptions and considering the SID and SII models' distortions equal ∀Δ,

R_{SID}(D)−R_{SII}(D)=E[log₂σ_{SID}(y)]−log₂σ_{SII}≦0, (9)

where, R_{SID}(D) and R_{SII}(D) are rates for a distortion level as given by an SID and an SII Laplacian model, respectively, and EN is the expectation operator. Theorem 1 specifies that, for a given L-2 distortion D, an SID (asymmetric) channel exhibits higher or equal correlation channel capacity compared to an SII (symmetric) channel. As a consequence, for a given L-2 distortion D, Slepian-Wolf coding (i.e. channel coding) for an SID channel is more efficient compared to that for an SII channel. Namely, the packing gain of Wyner-Ziv coding can be increased when using an SID instead of an SII modelling approach.

Since the alphabet of the noise is theoretically infinite, the output of the correlation channel X is continuous as well. If both Y and X are discrete or made discrete employing quantization or thresholding, the considered correlation channel drops down to an asymmetric discrete channel, as explained above.

A practical, rate-adaptive, layered Wyner-Ziv coding of a continuous source engendered by the application of additive, memoryless, SID Generalized Gaussian correlation noise on a discrete side-information signal is now described.

Facilitating scalability, layered Wyner-Ziv coding with nested scalar quantization (NSQ) and turbo-like (e.g. Turbo or LDPC) channel codes has been shown to approximate the rate-distortion performance of non-scalable Wyner-Ziv coding for additive, memoryless, SII Gaussian and Laplacian noise. In the considered Wyner-Ziv framework, sketched in FIG. 3, source clustering is realized with scalar quantization without nesting, hiring a high-dimensional channel code to perform Slepian-Wolf binning. The latter has shown performance equivalent to entropy constrained scalar quantization in predictive coding.

Concerning rate control, in early DSC designs, the correlation channel statistics are assumed to be stationary and perfectly known at both the encoder and the decoder. Under this assumption, the encoder and the decoder agree on an efficient channel code driven by the SW rate, that is the conditional entropy of the source given the side-information. However, in real-world applications, DSC frameworks face intricate barriers impeding perfect, a priori information on the correlation statistics. At the outset, the correlation channel exhibits highly non-stationary properties, that is the channel between the pair of N-tuples (xᵢ^{N},yᵢ^{N}) varies with the index i of the data (for instance, the SID correlation channel in distributed video coding varies spatially, i.e., within a WZ frame, and temporally, i.e., from WZ frame to WZ frame). Secondly, in DSC schemes, the source is available at the encoder, whereas the side-information is only formed at the decoder, which obstructs direct measurement of the correlation noise. Moreover, sophisticated correlation channel models—see the proposed model in Eq. (4)—encapsulate the side-information dependency of the noise, complicating the problem of online correlation channel estimation further.

Due to the aforementioned realistic limitations, a rate-adaptive Wyner-Ziv scheme employing a feedback channel from the decoder to the encoder seems an appealing rate control solution for many applications. This rate-adaptive scheme is also motivated by the assumed side-information dependency of the correlation noise, a channel property which induces decoder-driven correlation channel estimation.

In the considered rate-adaptive, layered Wyner-Ziv coding scheme (see FIG. 3) the decoder commences with a coarse estimation of the channel which is progressively enhanced upon decoding of the source bit planes. To code each source bit plane, the encoder transmits initially a weak channel code and the decoder attempts decoding based on the estimated channel statistics. In case of successful decoding, the decoder informs the encoder, to continue with the next block of source data. If decoding fails on the contrary, the encoder supplements the strength of the transmitted channel code, creating a longer syndrome based on a lower-rate code. This progression is carried on until the channel code is eligible for successful decoding. This method can be properly modified to support feedback channel constraints or even to completely suppress the feedback channel.

Without loss of generality, we continue by formulating our notations considering uniform quantization. However, the skilled person will readily understand that, with straightforward modifications, the correlation channel estimation techniques can be applied to Wyner-Ziv schemes employing any quantization approach.

Let x^{N}, y^{N} denote a source and side-information sample N-tuple, respectively. At the layered Wyner-Ziv encoder, every source sample x is quantized with an L-level uniform quantizer yielding a quantization index q in the range qε[0,L−1]. In particular, the total range R of the quantized source is divided into L=2^{M} intervals of the same size Δ=R/2^{M}, where M represents the total number of source bit planes. The operation of uniform quantization forms the vector of quantization indices q_{M}^{N}, each sample of which is given by qₘ=└(x−xₘᵢₙ)/Δ┘. After quantization, for each bit plane i, 1≦i≦M, the i-th bits in each quantization index are grouped into a binary N-tuple, denoted by bᵢ^{N}. Subsequently, each binary code word bᵢ^{N} is fed to the syndrome-based SW encoder forming syndrome or parity bits N-tuples which are stored in a buffer.

In the example below the employed syndrome-based SW coding is realized e.g. with the rate-adaptive LDPCA codes. The selection of LDPCA codes to implement good SW coding of the proposed SID correlation channel has not been done at random. In case of conventional symmetric communication channels, LDPC constructions have shown performance very close to the SW limit. Moreover, it has been claimed that turbo-like coding can be effectively employed for asymmetric channels. In the same direction, Density Evolution, a strong analytical tool of LDPC codes, has been extended to asymmetric channels and proposed good code constructions. In line with these findings, the rate-adaptive LPDCA codes performance has been shown not to degrade even when strong asymmetries, e.g. Z-channel statistics, are observed in the correlation channel. Yet, the proposed invention can operate in conjunction with any current SW and or channel code.

At the decoder, the estimated correlation channel statistics are interpreted to soft estimates, namely log-likelihood ratios (LLRs), per bit plane. In the formulation of the LLRs, information given by the side-information and the already decoded source bit planes is taken into account. In specific, let bₘ denote a bit of the m^{th} bit plane of the source, then the estimated LLRₘ at the corresponding variable node of the LDPCA decoder is given by:

$$\begin{matrix}{LLR}_{m} = log \frac{p ( {b}_{m} = 0 \vert y , {b}_{1} , … , {b}_{m - 1} )}{p ( {b}_{m} = 1 \vert y , {b}_{1} , … , {b}_{m - 1} )} \\ = log \frac{p ( {b}_{1} , … , {b}_{m - 1} , {b}_{m} = 0 \vert y )}{p ( {b}_{1} , … , {b}_{m - 1} , {b}_{m} = 1 \vert y )} ,\end{matrix} \qquad ( 10 )$$

since, p(bₘ=β|y, b₁, . . . , bₘ₋₁)=p(b₁, . . . , bₘ₋₁, bₘ=β|y)/p(b₁, . . . , bₘ₋₁|y), β={0,1}. For the side-information dependent Generalized Gaussian channel one can derive:

$${p}_{{Q}_{m} \vert Y} ( {q}_{m} \vert y ) = \{ \begin{matrix}\frac{1}{2} [ \begin{matrix}Q ( \frac{1}{α ( y )} , {[ η ( y ) ( {q}_{L} - y ) ]}^{α ( y )} ) - \\ Q ( \frac{1}{α ( y )} , {[ η ( y ) ( {q}_{H} - y ) ]}^{α ( y )} )\end{matrix} ] , & y < {q}_{L} \\ \frac{1}{2} [ \begin{matrix}P ( \frac{1}{α ( y )} , {[ η ( y ) ( y - {q}_{L} ) ]}^{α ( y )} ) + \\ P ( \frac{1}{α ( y )} , {[ η ( y ) ( {q}_{H} - y ) ]}^{α ( y )} )\end{matrix} ] , & {q}_{L} \leq y \leq {q}_{H} \\ \frac{1}{2} [ \begin{matrix}Q ( \frac{1}{α ( y )} , {[ η ( y ) ( y - {q}_{H} ) ]}^{α ( y )} ) - \\ Q ( \frac{1}{α ( y )} , {[ η ( y ) ( y - {q}_{L} ) ]}^{α ( y )} )\end{matrix} ] , & y > {q}_{H} ,\end{matrix} \qquad ( 11 )$$

where, q_{L}, q_{H} denotes the lower and upper bounds of the quantization bin qₘ indexed by b₁, . . . , bₘ, and P(.), Q(.) stand for the regularized lower and upper gamma incomplete functions, respectively.

Upon channel decoding of each Wyner-Ziv bit plane, the decoder updates the available Wyner-Ziv information, i.e. the already decoded binary N-tuples, and the proposed correlation channel estimation is executed. This means that, as additional Wyner-Ziv bit planes are decoded, the proposed approach enables online, progressive refinement of the estimated SID correlation channel parameters, namely the α(y), σ(y) functions.

After having decoded all the M bit planes, the M binary N-tuples b₁^{N}, b₂^{N}, . . . , b_{M}^{N} are combined to form the final quantization indices N-tuple qₘ^{N}, which is first employed to further refine the correlation channel estimation, and then is fed to the reconstruction module. Since the mean square error (MSE) distortion measure is employed, the optimal reconstruction of a source sample x is the centroid of the random variable X given the corresponding side-information sample y and the decoded quantization index q_{M}. For the side-information dependent Generalized Gaussian channel, one can derive the following:

$$E [ x \vert y , {q}_{M} ] = \{ \begin{matrix}y + \frac{\begin{matrix}Γ ( \frac{2}{α ( y )} , {[ η ( y ) ( {q}_{L} - y ) ]}^{α ( y )} ) - \\ Γ ( \frac{2}{α ( y )} , {[ η ( y ) ( {q}_{H} - y ) ]}^{α ( y )} )\end{matrix}}{2 η ( y ) Γ ( 1 / α ( y ) ) p ( {q}_{M} \vert y )} , & y < {q}_{L} \\ y + \frac{\begin{matrix}γ ( \frac{2}{α ( y )} , {[ η ( y ) ( {q}_{H} - y ) ]}^{α ( y )} ) - \\ γ ( \frac{2}{α ( y )} , {[ η ( y ) ( y - {q}_{L} ) ]}^{α ( y )} )\end{matrix}}{2 η ( y ) Γ ( 1 / α ( y ) ) p ( {q}_{M} \vert y )} , & {q}_{L} \leq y \leq {q}_{H} \\ y + \frac{\begin{matrix}Γ ( \frac{2}{α ( y )} , {[ η ( y ) ( y - {q}_{L} ) ]}^{α ( y )} ) - \\ Γ ( \frac{2}{α ( y )} , {[ η ( y ) ( y - {q}_{H} ) ]}^{α ( y )} )\end{matrix}}{2 η ( y ) Γ ( 1 / α ( y ) ) p ( {q}_{M} \vert y )} , & y > {q}_{H} ,\end{matrix} \qquad ( 12 )$$

where, q_{L},q_{H} denotes the lower and upper bounds of the quantization bin q_{M}, p(q_{M}|y) is given by the formulas in (11).

Now is described the proposed algorithm which performs successively refined estimation of the correlation channel encountered between the i^{th} block of source data xᵢ^{N} and the corresponding side-information yᵢ^{N}.

In a nutshell, the decoder combines the already SW decoded bit planes of the source with the side-information signal to estimate the SID correlation channel. The refined channel estimates are thereafter employed to decode the next bit plane. After decoding all the bit planes, the algorithm is preferably executed again so as to refine the channel estimates for the optimal reconstruction of the source. Prior to SW decoding of the first source bit plane, denoted by b₁^{N}, the decoder is completely uninformed concerning the source. In this case, an initial prediction of the SID channel statistics is extrapolated by the previously decoded source block and its corresponding side-information. Namely, an initial coarse estimation of the SID correlation channel, employed to decode the first SW bit plane i^{th} source data block, is derived from the previous observation of the channel statistics, denoted by p(xᵢ₋₁^{N}|yᵢ₋₁^{N}). The more bit planes are available at the decoder, the more accurate the estimation of the channel statistics becomes. Thus, the proposed algorithm enables progressive refinement of the correlation channel.

The following steps describe the successive refinement procedure adopted in the proposed correlation channel estimation algorithm.
1. Let m, 1≦m≦M, denote the number of decoded bit planes, i.e. the binary N-tuples b₁^{N}, b₂^{N}, . . . , bₘ^{N}, of the source block data at the decoder. The decoder combines the available b₁^{N}, b₂^{N}, . . . , bₘ^{N} binary N-tuples to produce a coarse description, qₘ^{N}, of the source, x^{N}, containing quantization indices in the range qₘ^{N}ε[0,2^{m}−1]. Note that in the following the index i is dropped in the notation of the source data block.
2. Thereafter, the correlation estimator measures the joint probability mass function (PMF) of the rough source description and the side-information, p_{Q}_{ₘ}_{,Y}(qₘ, y), using the histogram.
3. Then, the empirical conditional PMF is calculated using the Bayes' law:

$${p}_{{Q}_{m} \vert Y} ( {q}_{m} \vert y ) = {p}_{{Q}_{m} , Y} ( {q}_{m} , y ) / {\sum }_{l = 0}^{{2}^{m} - 1} {p}_{{Q}_{m} , Y} ( {q}_{{ }_{m , l}} , y ) , \qquad ( 13 )$$

where q_{m,1}, denotes the l^{th} quantization index, or bin lε[0,2^{m}−1]. Eq. 13 gives the transition matrix p_{Q}_{ₘ}_{|Y}(qₘ|y) of a discrete channel having the side-information as input and the m-level quantization index of source as output. This can be depicted with the following notation:

$${p}_{{Q}_{m} \vert Y} ( {q}_{m} \vert y ) = [ \begin{matrix}{p}_{{Q}_{m} \vert Y} ( {q}_{m , 0} \vert {y}_{0} ) & … & {p}_{{Q}_{m} \vert Y} ( {q}_{m , l} \vert {y}_{0} ) & … & {p}_{{Q}_{m} \vert Y} ( {q}_{m , L} \vert {y}_{0} ) \\ ⋮ & & ⋮ & & ⋮ \\ {p}_{{Q}_{m} \vert Y} ( {q}_{m , 0} \vert {y}_{k} ) & … & {p}_{{Q}_{m} \vert Y} ( {q}_{m , l} \vert {y}_{k} ) & … & {p}_{{Q}_{m} \vert Y} ( {q}_{m , L} \vert {y}_{k} ) \\ ⋮ & & ⋮ & & ⋮ \\ {p}_{{Q}_{m} \vert Y} ( {q}_{m , 0} \vert {y}_{K} ) & … & {p}_{{Q}_{m} \vert Y} ( {q}_{m , l} \vert {y}_{K} ) & … & {p}_{{Q}_{m} \vert Y} ( {q}_{m , L} \vert {y}_{K} )\end{matrix} ] \qquad ( 14 )$$

4. Each row of the empirically acquired transition matrix of (14), denoted by p_{Q}_{ₘ}_{|Y}(qₘ|yₖ), ∀yₖεA_{Y} defines the PMF which would be derived by scalar quantization of the unknown Generalized Gaussian distribution centred on yₖ. The higher the number of the quantized source samples per each realization yₖ of the side-information, the more accurate the empirically calculated PMF becomes. Therefore, the algorithm can employ the empirically measured PMF to determine the unknown parameters of the correlation noise per side-information realization. In order to estimate the shape and standard deviation parameters, denoted by α(yₖ),σ(yₖ) respectively, of each Generalized Gaussian distribution ∀yₖεA_{Y}, one needs to find the roots of the following two-dimensional function

$$\begin{matrix}g ( α ( {y}_{k} ) , σ ( {y}_{k} ) ) = {p}_{{Q}_{m} \vert Y} ( {q}_{m , l} \vert {y}_{k} ) = {\int }_{{q}_{L}}^{{q}_{H}} \frac{η ( {y}_{k} ) α ( {y}_{k} )}{2 Γ ( 1 / α ( {y}_{k} ) )} {e}^{- {[ η ( {y}_{k} ) \vert x - {y}_{k} \vert ]}^{α ( {y}_{k} )}} d x , & ( 15 ) \\ ∀ {y}_{k} ∈ {A}_{Y} , & \end{matrix}$$

where q_{L}, q_{H} are the lower and upper bounds of the quantization bin with index q_{m,I}. For every yₖ, one has 2^{m} quantization indices or columns in the transition matrix, that is, there are 2^{m} equations of the form gₗ(α(yₖ),σ(yₖ))=0, 0≦l≦2^{m}−1 each of which is satisfied by the unknowns α(yₖ),σ(yₖ). Employing the formulas given in (11), Eq. 15 can be developed as follows:

$$g ( α ( {y}_{k} ) , σ ( {y}_{k} ) ) = \{ \begin{matrix}\begin{matrix}2 \cdot {p}_{{Q}_{m} \vert Y} ( {q}_{m , l} \vert {y}_{k} ) - Q ( \frac{1}{α ( {y}_{k} )} , {[ η ( {y}_{k} ) ( {q}_{L} - {y}_{k} ) ]}^{α ( {y}_{k} )} ) + \\ Q ( \frac{1}{α ( {y}_{k} )} , {[ η ( {y}_{k} ) ( {q}_{H} - {y}_{k} ) ]}^{α ( {y}_{k} )} ) ,\end{matrix} & {y}_{k} < {q}_{L} \\ \begin{matrix}2 \cdot {p}_{{Q}_{m} \vert Y} ( {q}_{l , m} \vert {y}_{k} ) - P ( \frac{1}{α ( {y}_{k} )} , {[ η ( {y}_{k} ) ( {y}_{k} - {q}_{L} ) ]}^{α ( {y}_{k} )} ) - \\ P ( \frac{1}{α ( {y}_{k} )} , {[ η ( {y}_{k} ) ( {q}_{H} - {y}_{k} ) ]}^{α ( {y}_{k} )} ) ,\end{matrix} & {q}_{L} \leq {y}_{k} \leq {q}_{H} \\ \begin{matrix}2 \cdot {p}_{{Q}_{m} \vert Y} ( {q}_{l , m} \vert {y}_{k} ) - Q ( \frac{1}{α ( {y}_{k} )} , {[ η ( {y}_{k} ) ( {y}_{k} - {q}_{H} ) ]}^{α ( {y}_{k} )} ) + \\ Q ( \frac{1}{α ( {y}_{k} )} , {[ η ( {y}_{k} ) ( {y}_{k} - {q}_{L} ) ]}^{α ( {y}_{k} )} ) ,\end{matrix} & {y}_{k} > {q}_{H} .\end{matrix} \qquad ( 16 )$$

The following scenarios are defined concerning the nature of the Generalized Gaussian channel estimation problem:
A. First a generic scenario, according to which the decoder is completely uninformed about the statistics of the correlation channel. That is, the decoder has no information about the standard deviation and shape parameter functions, i.e. α(y),σ(y), of the SID Generalized Gaussian channel. In this scenario, the decoder can determine the unknowns α(yₖ),σ(yₖ) ∀yₖεA_{Y} by solving the system of nonlinear equations defined by:

gₗ(α(yₖ),σ(yₖ))=0,0≦l≦2^{m}−1,∀yₖεA_{Y} (17)
By observing the formulas in (16), one notices that the system of nonlinear equations described by (17) cannot be solved analytically. Therefore, the problem of determining the unknowns α(yₖ),σ(yₖ) ∀yₖεA_{Y} is transformed to the problem of constraint minimization of a two-dimensional cost function, given by:

$$\begin{matrix}〈 α ( {y}_{k} ) , σ ( {y}_{k} ) 〉 = arg {min}_{\{ α ( {y}_{k} ) , σ ( {y}_{k} ) \geq 0 \}} {\sum }_{l = 0}^{{2}^{m} - 1} {[ {g}_{l} ( α ( {y}_{k} ) , σ ( {y}_{k} ) ) ]}^{2} , & ( 18 ) \\ ∀ {y}_{k} ∈ {A}_{Y} . & \end{matrix}$$

The problem defined by (18) can be solved numerically using well-known, fast algorithms, for nonlinear continuous optimization, namely sequential quadratic programming (SQP).
B. In the second scenario, the decoder is not completely uninformed but is aware of the shape parameter function α(y) of the SID Generalized Gaussian channel. This scenario finds practical application in the special case where the correlation channel noise follows a standard SID distribution, that is α(yₖ)=α, ∀yₖεA_{Y}. In this case, eq. (15) becomes the following one-dimensional function:

$$\begin{matrix}g ( σ ( {y}_{k} ) ) = {p}_{{Q}_{m} \vert Y} ( {q}_{m , l} \vert {y}_{k} ) = {\int }_{{q}_{L}}^{{q}_{H}} \frac{η ( {y}_{k} ) α}{2 Γ ( 1 / α )} {e}^{- {[ η ( {y}_{k} ) \vert x - {y}_{k} \vert ]}^{α}} d x , & ( 19 ) \\ ∀ {y}_{k} ∈ {A}_{Y} & \end{matrix}$$

and the decoder needs to estimate only the standard deviation parameter σ(yₖ),∀yₖεA_{Y}. For instance, in case α=1, that is, the correlation noise simplifies to the SID Laplacian PDF, the g(σ) function of (19) is defined as:

$$g ( σ ( {y}_{k} ) ) = \{ \begin{matrix}2 \cdot {p}_{{Q}_{m} \vert Y} ( {q}_{m , l} \vert {y}_{k} ) - {e}^{- \frac{\sqrt{2}}{σ} ( {q}_{L} - {y}_{k} )} + {e}^{- \frac{\sqrt{2}}{σ} ( {q}_{H} - {y}_{k} )} , & {y}_{k} < {q}_{L} \\ 2 \cdot {p}_{{Q}_{m} \vert Y} ( {q}_{m , l} \vert {y}_{k} ) - 2 + {e}^{\frac{\sqrt{2}}{σ} ( {q}_{L} - {y}_{k} )} + {e}^{- \frac{\sqrt{2}}{σ} ( {q}_{H} - {y}_{k} )} , & {q}_{L} \leq {y}_{k} \leq {q}_{H} \\ 2 \cdot {p}_{{Q}_{m} \vert Y} ( {q}_{m , l} \vert {y}_{k} ) - {e}^{\frac{\sqrt{2}}{σ} ( {q}_{H} - {y}_{k} )} + {e}^{\frac{\sqrt{2}}{σ} ( {q}_{L} - {y}_{k} )} , & {y}_{k} > {q}_{H} .\end{matrix} \qquad ( 20 )$$

Since the decoder needs to estimate only one unknown ∀yₖεA_{Y}, namely the α(yₖ) parameter, only one out of the 2^{m} nonlinear equations of the form gₗ(σ(yₖ))=0, 0≦l≦2^{m}−1∀yₖεA_{Y} is required to solve the problem. It can be proven that only the nonlinear equations derived from the quantization bin for which q_{L}≦yₖ≦q_{H}, namely the second equation in (16) and (20), has one and only one solution in σ(yₖ)ε[0,+∞). Hence, the correlation channel estimation module can find the solution of the nonlinear equation g(σ(yₖ)=0 for q_{L}≦yₖ≦q_{H} numerically using a fast algorithm which combines bisection, secant and inverse quadratic interpolation methods.

However, for the SID Laplacian PDF, when yₖ=q_{L} or yₖ=q_{H} (i.e. when the realization of the side-information coincides with the upper or lower bound of the considered quantization bin), the solution of g(σ(yₖ))=0 can be found analytically, as follows:

$$σ ( {y}_{k} ) = - \frac{{2}^{( M - m ) / 2}}{ln ( 1 - 2 \cdot {p}_{{Q}_{m} [ X ] \vert Y} ( {q}_{{ }_{l , m}} [ x ] \vert {y}_{k} ) )} . \qquad ( 21 )$$

After SW decoding of a bit plane, a more accurate description of the source is provided to the correlation channel estimation module and the proposed algorithm is executed again. The process is repeated recursively, enabling a progressive refinement of the SID correlation channel estimation. This is of paramount significance since for every additional bit plane WZ quantization becomes finer, thus the impact of inaccurate channel estimation on the coding efficiency increases.

A practical example is now considered for a video coding application. A hash-based distributed video coding architecture is proposed, which delivers significantly improved compression efficiency over prior art systems, while involving very low computational complexity and memory usage at the encoder. The block diagrams of the proposed pixel- and transform domain codecs are depicted in FIG. 4 and FIG. 5, respectively. At the encoder, the input video sequence is organized into Groups of Pictures (GOPs) and is decomposed into key frames, i.e., the first frame in each GOP, and WZ frames. The key frames, denoted by I, are encoded using H.264/AVC Intra frame coding. The Wyner-Ziv (WZ) frames are encoded in two parts, a hash layer and a WZ layer.

The hash information comprises a coarsely quantized version of the luminance components of the original WZ frames and enables the construction of the side-information frame Y by means of the overlapped block motion estimation and compensation block, as further explained in detail below. The hash information comprises one or more of the most significant bit planes of the possibly subsampled luminance component. To construct the hash information, the WZ frames X are subject to coarse uniform scalar quantization with a quantization step size 2^{M-b}, where M denotes the bit-depth of the original samples and b represents an integer indicating the number of bit planes of the hash. This operation yields the quantized frame \tilde{X}, containing quantization indices Q_{HASH}(X)=└X/2^{M-b}┘ in the range [0,2^{b}−1]. Each quantized frame X is then decorrelated using spatio-temporal prediction. An adaptive prediction can be used that constitutes a low-complexity binary equivalent of the well-known edge-adaptive JPEG-LS predictor. Let \tilde{X}ₙ(s) denote the quantization index at position s=(i,j) in each quantized WZ frame \tilde{X}ₙ, 0≦n<N, N being the total number of WZ frames. As shown in FIG. 6, the index \tilde{X}ₙ(s) forms the intersection of a spatial plane P_{S}, containing the left, top and diagonal neighbouring samples \tilde{X}ₙ(sₗ)=\tilde{X}ₙ(i−1,j), \tilde{X}ₙ(sₜ)=\tilde{X}ₙ(i,j−1) and \tilde{X}ₙ(s_{d})=\tilde{X}ₙ(i−1, j−1) respectively, and two temporal planes P_{T1} and P_{T2} containing and \tilde{X}ₙ(sₗ), \tilde{X}ₙ₋₁(sₗ), \tilde{X}ₙ₋₁(s) and \tilde{X}ₙ(sₗ), \tilde{X}ₙ₋₁(sₗ), \tilde{X}ₙ₋₁(s), respectively. For each of these planes ρε{P_{S}, P_{T1}, P_{T2}}, a predictor p_{ρ}(\tilde{X}ₙ) is derived as shown in FIG. 6. \tilde{X}ₙ(s), the final prediction for \tilde{X}ₙ(s), is then calculated as the median of the three predictors p_{ρ}(\tilde{X}ₙ),ρε{P_{S}, P_{T1}, P_{T2}}. Note that for \tilde{X}₀, i.e. the first WZ frame in the sequence, the temporally neighbouring frame is not available. In this case, the prediction reverts to p_{P}_{_{S}} (\tilde{X}₀). After the prediction stage, the prediction errors, being in the range [−\tilde{X}ₙ(s),2^{b}−1−\tilde{X}ₙ(s)], are mapped to a new set of symbols ranging between [0,2^{b}−1] by employing modulo arithmetic, as in JPEG-LS. These symbols are then converted to sequences of binary symbols (bins) using unary coding. Each bin is subsequently coded using binary arithmetic coding. Three probability models are used to code the first bin. The employed model is selected depending on whether the top and left spatially neighbouring prediction errors are zero-valued. The remaining bins in the sequence are coded with a single probability model per bin.

In the second stage, for each WZ frame, the residual information between the original samples and the hash values, i.e. X_{M-b}=X−Q_{HASH}⁻¹(\tilde{X}), is formed. In order to obtain residual values greater than or equal to zero, the reconstruction of the hash quantization is performed at the lower bound of the uncertainty interval, i.e. X_{M-b}=X−└X/2^{M-b}′·2^{M-b}.

The obtained residual information is WZ coded either in the pixel- or in the transform-domain forming the WZ layer of the proposed DVC architectures. The implementation of the WZ codec may for example be based on the disclosure “Distributed Video Coding” (B. Girod et al., Proc. IEEE, vol. 93, no. 1, pp. 71-83, Jan. 2005).

Specifically, in the pixel-domain, the residual frame is subject to uniform scalar quantization with a step size given by 2^{M-b-d}. The parameter d controls the WZ quantization step size and also represents the number of bit planes of the residual information to be WZ coded.

In the transform domain the residual frame values undergo first at the encoder a 4×4 integer discrete cosine transform (DCT). The DCT coefficients are then grouped together into bands β which are independently quantized with 2^{L}^{_{β}} levels. A uniform and a double-deadzone scalar quantizer are employed for the DC and the AC bands, respectively. A set of predefined quantization matrices (QM) is used for the transformed residual information. After quantization, in both architectures, the quantized symbols are converted to binary code words and fed to the Slepian-Wolf (SW) encoder. The employed SW coding needs to cope with the asymmetric nature of the SID correlation channel. SW coding can be realized using the rate-adaptive LDPC Accumulate (LDPCA) codes, the performance of which is not degraded even when the correlation channel features strong asymmetries. The derived syndrome bits per code word are stored in a buffer and a feedback channel is used to allow optimal rate control.

At the decoder, the Intra and hash bit streams are demultiplexed. The intra bit stream is H.264/AVC decoded and the intra frames are stored in a reference frame buffer. The hash is decoded by inverting the tasks applied at the encoder, i.e. entropy decoding and inverse spatio-temporal prediction, and the obtained bit planes \tilde{X} are stored. Next, overlapped block motion estimation and probabilistic compensation (OBMEPC) is used to estimate the missing M−b bit planes Y_{M-b} in the side-information, producing the side-information frame Y=Q_{HASH}⁻¹(\tilde{X})+Y_{M-b}.

In the pixel-domain architecture, subsequently to OBMEPC, the decoder utilizes the hash information, comprised by the b most significant WZ bit planes, and the SI frame created by OBMEPC to perform online estimation of the SID correlation channel. Based on the estimated array of sigmas, i.e. σ(y), and the value of the side-information at each pixel position, the decoder produces soft estimates used to decode the WZ bit planes. After decoding each bit plane, the bit plane is stored in a bit plane buffer and correlation channel estimation is executed again enabling successive refinement of the σ(y) estimates. After decoding the final WZ bit plane, the σ(y) estimates are again updated so they can be used in the reconstruction process. After SW decoding, both the WZ and hash bit planes are forwarded to the reconstruction module were optimal MMSE estimation is applied based on the SI and the σ(y) estimates.

In the transform-domain architecture (see FIG. 5), following OBMEPC, the decoder generates the residual side-information frame, Y_{M-b}, which is DCT transformed, forming the SI for the WZ layer. Correlation estimation is performed in a successively refined fashion similar to the pixel-domain. Nevertheless, in contrast to the pixel-domain, for the transform-domain WZ layer the first bit plane per band which is required to initiate the correlation estimation algorithm is not available prior to SW decoding. In this case, the SID channel estimates per band are obtained by the reconstructed previous frame and its corresponding SI. After decoding all the bit planes of the WZ coded bands, optimal reconstruction and inverse DCT are carried out providing the residual reconstructed frame \tilde{X}_{M-b}, which is added back to the stored hash information, yielding the reconstructed WZ frame \tilde{X}.

The bit plane overlapped block motion estimation (OBME) can be performed as described in detail in WO2009/62979. It operates on a hierarchical prediction structure. Using the reconstruction of two previously encoded WZ and/or key-frames as past and future reference frames, the decoder performs OBME using the hash information, i.e. the available b most significant luminance bit-planes of the current WZ frame. The WZ frame is divided into overlapping spatial blocks. For each block the best matching block within a specified search-range is found in each of the reference frames. The employed matching criterion maximizes the complement 1−PER of the so-called pixel error ratio PER) calculated on the available b most significant bit-planes between the current block in the WZ frame and a block in a reference frame. The measure 1−PER is defined as the number of quantized indices in the reference frame block which are identical to those of the co-located quantization indices in the current block, divided by the total number of samples in the block. Finally, for each overlapping WZ block two temporal prediction blocks (one for each reference frame) and the associated correlation estimates are obtained. Each pixel in the WZ frame is then linked to a number of corresponding candidate predictors. Out of these candidate predictors, only the ones for which the b most significant bit-planes are identical to the ones of the considered WZ pixel, are retained and referred to as valid predictors. The remaining invalid predictors are discarded. Based on the hash information and the retained predictors high quality side-information is produced.

FIG. 7 proposes another hash-based DVC architecture which delivers significantly improved compression efficiency over contemporary DVC systems, while involving very low computational complexity and memory usage at the encoder.

As before, the input sequence at the encoder is organised in GOPs and is decomposed into key frames, i.e., the first frame in each GOP, and WZ frames. The key frames, denoted by I, are encoded using H.264/AVC Intra frame coding. For each WZ frame, a novel hash is sent to aid side information creation at the decoder (see below for more details). In addition to the coded hash, a WZ bit-stream is formed for each WZ frame. This may in one embodiment be based on the transform-domain WZ (TDWZ) architecture. As opposed to hash-driven prior art schemes the WZ encoder is in one embodiment advantageously chosen to encode the original WZ frame—rather than its difference with the hash—in order to preserve the error resilient traits of WZ coding for the entire WZ frames' waveform. Whereas in prior art solutions the computational expensive tasks of motion estimation, rate control and mode decision are performed at the encoder, the proposed scheme aims at efficient yet very low-cost DVC scheme.

Specifically, at the encoder, the WZ frame's pixel values are transformed using the 4×4 separable integer transform as in H.264/AVC, which has properties similar to the discrete cosine transform (DCT). Using a set of predefined quantization matrices (QMs), each DCT band β is independently quantized with 2^{L}^{_{β}} levels. A uniform and a double-deadzone scalar quantizer are employed for the DC and the AC bands, respectively. After quantization, the quantization indices are converted into binary code words and fed to the SW encoder.

At the decoder, the intra frames are H.264/AVC Intra decoded and stored in a reference frame buffer. The hash information is decoded by inverting the tasks applied at the encoder. Next, an overlapped block motion estimation with subsampled reference frames technique is used to generate a motion-compensated prediction of the WZ frame based on the received hash and reference frames. Subsequently, the produced motion-compensated frame is DCT transformed, forming the SI for the WZ codec.

Thereafter, per coded DCT band β of the WZ frame, the decoder performs the proposed online SID correlation channel estimation algorithm. Per band β of the WZ frame, the decoder produces soft estimates to decode the WZ bit-planes based on the SID channel estimates, σ_{β}(yₖ), and the value of each SI coefficient. After decoding each bit-plane of a band of the WZ frame, the bit-plane is stored in a buffer and the algorithm is executed again enabling bit-plane-by-bit-plane progressive refinement of the σ_{β}(yₖ) estimates. After decoding the final WZ bit-plane of the band of the WZ frame, the σ_{β}(yₖ) estimates are again updated yielding improved estimation for the reconstruction process. After decoding all the bit-planes of all WZ coded bands of the WZ frame, minimum mean square error (MMSE) reconstruction and inverse DCT are carried out, yielding the reconstructed WZ frame \hat{X}.

The proposed hash information \tilde{X}consists of the most significant bit-plane (MSB) of the dyadically sub-sampled luminance component of the original WZ frame X. To encode this information, each binary value \tilde{X}(s) at position s=(i,j) in the hash is first spatially predicted. The employed prediction scheme is essentially a low-complexity binary equivalent of the well-known edge-adaptive JPEG-LS predictor. More specifically, each binary value \tilde{X}(s) is predicted by a Boolean function \tilde{X}′(s)=(a+b)· c̅+a·b, with a, b and c denoting the left, top and top-left neighbouring binary values in the hash, respectively, as shown in FIG. 8. After the prediction stage, each prediction error \tilde{X}″(s)=\tilde{X}(s)⊖\tilde{X}′(s) is directly calculated using a single exclusive-or operation between the predictor \tilde{X}′(s) and the predicted value \tilde{X}(s). Finally, each binary symbol \tilde{X}″(s) is coded using multiplication-free context-based binary arithmetic coding employing one of eight different probability models. The probability model is selected based on the neighbouring local gradients b−c, c−a and d−b in the original hash \tilde{X}, with d denoting the top-right neighbour of the predicted value \tilde{X}(s) (see FIG. 8).

The proposed hash formation and coding processes are designed in order to impose a limited complexity and memory usage overhead at the encoder. First, the hash is formed based on the sub-sampled pixel values, requiring only ¼ of the samples to be further processed. Secondly, the spatial prediction process can be implemented using simple binary arithmetic, making it ideal for hardware implementation. Thirdly, the proposed technique does not perform any block-based decisions on the transmission of hash information at the encoder side. Hence, it is not burdened by the computationally expensive block-based comparisons required for such mode decision, nor does it require storing reference information from temporally adjacent frames. No temporal prediction is applied by the proposed hash encoder, thereby preventing error propagation between the hash data of consecutive WZ frames.

A scheme for bit plane overlapped block motion estimation with subsampled reference frames is now described. It constitutes a powerful technique which generates accurate SI at the decoder based on the proposed hash.

Overlapped Block Motion Estimation (OBME) is performed in a hierarchical prediction structure similar to MCI-based DVC systems. As before, the decoder performs OBME based on the proposed hash, thereby using two previously decoded WZ and/or key frames as past and future reference frames. Specifically, let Rₖ, kε{0,1} denote the reference frames and let Rₖ, kε{0,1} denote the MSB of the luminance component of Rₖ, kε{0,1}. Also, let \tilde{X} denote the decoded hash frame. Due to the lower resolution of the hash frame \tilde{X}, the values in each binary frame \tilde{R}ₖ are reorganized into 4 sub-sampled reference frames, i.e., \tilde{R}ₖ^{p,q}, p,qε{0,1}, by separating the values at even and odd positions in \tilde{R}ₖ as \tilde{R}ₖ^{p,q}(s)=\tilde{R}ₖ(2s+(p,q)) (see FIG. 8). In this way, the newly formed binary reference frames \tilde{R}ₖ^{p,q} have the same resolution as the hash frame \tilde{X}, hence facilitating the execution of OBME. Next, based on \tilde{X} and \tilde{R}ₖ^{p,q}, down-scaled motion vectors between the WZ frame and the reference frames are found by OBME. Note that OBME derives more than one motion vector per pixel, thereby decreasing the energy of the prediction error. Also blocking artefacts are drastically reduced, thus increasing the subjective quality of the decoded frame.

The OBME process proceeds as follows. Using an overlap step-size ε, the hash frame is divided into overlapping blocks \tilde{X}ᵤ of size B×B samples, with top-left coordinates u=(u₁,u₂). For each overlapping block \tilde{X}ᵤ, the best matching block within a specified search-range sr is found in one of the sub-sampled reference frames \tilde{R}ₖ^{p,q}. The employed matching criterion maximizes the number of binary values in the hash block \tilde{X}ᵤ that are identical to the co-located binary values in the block \tilde{R}_{k,u-v}^{p,q}, where v=(v₁,v₂) is the associated motion vector. Therefore, for each overlapping block \tilde{X}ᵤ in the hash frame, OBME has identified the motion vector v and the indices k,q,p which define the best reference block \tilde{R}_{k,u-v}^{p,q}. In addition, OBME retains the corresponding matching strength wᵤ for the overlapping block \tilde{X}ᵤ, which will be used in the SI generation process. The matching strength wᵤ is defined as the number of binary values in \tilde{X}ᵤ that are identical to the co-located binary values in the best reference block \tilde{R}_{k,u-v}^{p,q} divided by B², i.e., the total number of samples in a block. Remark that due to the nature of the new hash, the matching process is carried out with binary comparisons, thereby vastly diminishing the associated complexity.

To generate SI, the motion vectors derived by OBME are first up-sampled. By construction, there is a direct correspondence between every block \tilde{X}ᵤ (with top-left coordinates u and size B×B pixels) in the hash frame and the block Y₂ᵤ (with top-left coordinates 2u=(2u₁,2u₂) and size 2B×2B pixels) covering the SI frame Y. As a result, based on v and k,q,p found by OBME for the hash block \tilde{X}ᵤ, an equivalent motion vector, i.e., v′=2v+(p,q), to the original reference frame Rₖ can be derived for the SI block Y₂ᵤ. In this way, for each overlapping block Y₂ᵤ in the SI frame, a temporal predictor block, denoted by Ψ_{k,2u}, is determined in the reference frame Rₖ.

After scaling the motion vectors, each pixel in the SI frame belongs to a number of overlapping blocks Y₂ᵤ_{_{c}}, c=1 . . . C. This means that, each pixel in the SI frame is linked to a number of predictors Ψ_{k,2u}_{_{c}}, c=1 . . . C, being the co-located pixel values in the blocks Ψ_{k,2u}_{_{c}}. Each SI pixel value is then derived by properly combining its predictors. In detail, for the even pixel positions in the SI frame, the MSB of the original frame X was transmitted in the hash k. This binary value is used to determine the weight of the predictor during compensation. Specifically, if the binary value in the hash agrees with the MSB of a predictor Ψ_{k,2u}_{_{c}}, then the predictor is said to be verified and its weight is equal to the associated matching strength wᵤ_{_{c}}. Otherwise, the predictor is categorized as unverified and its weight is empirically set to the lowest value, that is, 1/B². For the other pixels in the SI frame, for which hash information is unavailable, simple averaging of their corresponding predictors is applied to derive the SI values.

The generated motion estimation vectors are also used to produce the chrominance components of the WZ frame at the decoder, generating candidate predictors based on the chrominance components of the reference frames. The weights derived for the even positions in the luminance component are employed in the weighted averaging of the predictors.

The DVC architecture shown in FIG. 7 can advantageously be applied in a wireless capsule endoscopic video application. A capsule endoscope is a device at the size of a large pill, composed of a limited lifespan battery, a strong light source, an integrated chip video camera, and a radio telemetry transmitter. Once swallowed, the capsule transmits video of the esophagus, stomach and small intestine to a sensor array placed around the patient's abdomen. Endoscopic video content exhibits highly erratic motion characteristics, e.g., low frame acquisition rates, and extreme camera panning caused by gastrointestinal contractions. In sequences with irregular motion characteristics, conventional MCI techniques fail to deliver fair prediction quality due to blind motion estimation. To overcome this problem, a DVC architecture as in FIG. 7 is well suited. In the modified DVC architecture of FIG. 7 for capsule endoscopy, the hash information comprises of a reduced resolution version of each WZ frame coded at a low quality. In particular, to form the hash, the WZ frame first undergoes a down-scaling filter operation with a factor of dε [symbol] ₊. Then, the downsampled WZ frame is conventionally intra coded (e.g., with H.264/AVC Intra or Motion JPEG) at a much lower quality compared to the quality of the key frames. Unlike the previously described SI generation approach, in which motion estimation was bit-plane-based, OBME has been appropriately modified so as to ensure compatibility and efficiency with the hash, as specifically designed for capsule endoscopy.

Before some numerical results are given in order to show the benefit of the proposed correlation channel estimation algorithm, an offline side-information dependent channel estimator is presented that serves as a reference enabling the accuracy assessment of the corresponding online algorithm.

Offline SID correlation estimation is an ideal but unrealistic approach, since it assumes that the original frame pixel values are present at the decoder. Under this assumption, the decoder can form the transformed noise frame, i.e., N(t)=X(t)−Y(t), t=(βᵢ,ζᵢ), where X(t) and Y(t) denote the DCT transformed WZ and SI frame's coefficient of the band βᵢ and the block ζᵢ. Per coded band of a WZ frame, offline SID correlation channel estimates are independently determined.

DCT coefficients are real numbered, so practically, in order to have a discrete number of SID sigma values, one needs to group the SI frame coefficients of each band β. Then, for every coded band β and transformed SI quantization index yₖ, the corresponding offline SID estimate is

σ_{β}(yₖ)=\sqrt{E[N²(t)]−E²[N(t)]},∀tε{t=(βᵢ,ζᵢ)|βᵢ=β,Q_{L}_{_{β}}(Y(t))=yₖ,yₖε[0,2^{L}^{_{β}}−1]}, (22)

where, Q_{L}_{_{β}}(•) denotes the quantization of the SI frame coefficients of band β, and 2^{L}^{_{β}} is the number of quantization levels (QLs) for band β. Eq. (22) implies that, per band β of a WZ frame, σ_{β}(yₖ) is estimated as the standard-deviation of the transformed noise frame coefficients of which the corresponding SI coefficient value falls into the quantization bin indexed by yₖ. For both the proposed offline and online SID algorithms, the best RD performance is obtained based on a balance between the SID noise stationarity level, the number of QLs of the SI frame coefficients per band, and the statistical support to accurately estimate the SID σ_{β}(yₖ) parameters. It was empirically observed that the highest RD performance for the proposed offline and online SID algorithms is obtained when the SID channel is considered stationary at band-level and the number of QLs per band is identical to the number of QLs employed to quantize the values of the transformed original frame at the encoder.

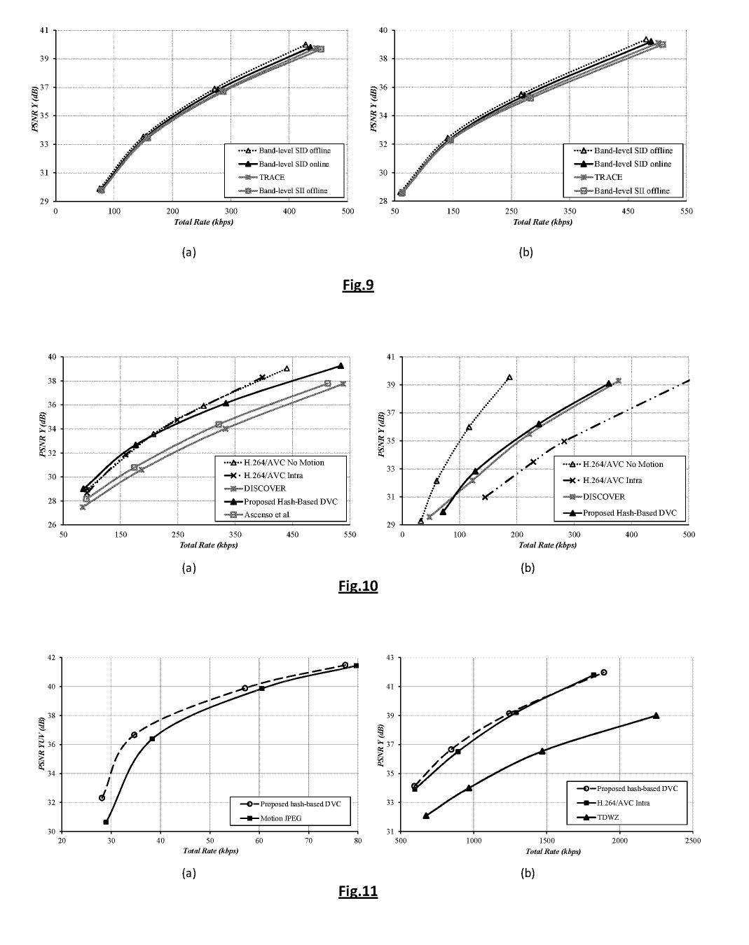

Considering the DVC architecture of FIG. 7, FIG. 9 depicts the RD comparison of the proposed online SID algorithm against the offline band-level SII channel estimation of Brites and Pereira (“Correlation noise modeling for efficient pixel and transform domain Wyner-Ziv video coding”, IEEE Trans. Circuits Syst. Video Technol., vol. 18, no. 9, pp. 1177-1190, September 2008), and the state-of-the-art TRACE method of Fan et al. (“Transform-domain adaptive correlation estimation (TRACE) for Wyner-Ziv video coding”, IEEE Trans. Circuits Syst. Video Technol., vol. 20, no. 11, pp. 1423-1436, November 2010). FIG. 9 also includes the coding results obtained with offline SID estimation, which serves as an ideal SID channel estimate. The results reveal that offline SID estimation yields the best coding performance among the assessed methods, thus verifying the theoretical capacity of SID versus SII modelling. The performance achieved with online SID is close to that obtained with offline SID estimation, hence confirming that the proposed online SID algorithm accurately estimates the SID channel statistics. It is also notable that online band-level SID estimation consistently outperforms the offline band-level SII method of Brites and Pereira, yet the latter is impractical. One observes that the gain brought by the proposed online SID method over the offline band-level SII method increases with rate, since progressive refinement allows the proposed online SID method to improve its estimation accuracy as more information is decoded.

The proposed online SID algorithm delivers higher compression efficiency than the state-of-the-art TRACE technique. TRACE enables coefficient-based estimation, which is progressively refined across the DCT bands during decoding. Nevertheless, TRACE builds on the SII paradigm and supports a coarser refinement granularity, namely, band-based versus bit-plane-based refinement in the proposed SID estimation.

FIG. 10 depicts the coding performance of the hash-based DVC codec of FIG. 7, equipped with the invention, against a relevant set of state-of-the-art low-cost video encoding schemes. The results illustrate that the proposed codec outperforms DISCOVER. In general the more irregular the coded motion content is, the higher the compression gain of the proposed method over the state-of-the-art DISCOVER codec. Furthermore, the experimental results in FIG. 10 dictate that the hash-based DVC codec of FIG. 7, equipped according to the invention, outperforms the latest hash-based DVC prior art, namely, the codec of Ascenso et al. (“A flexible side information generation framework for distributed video coding” Multimedia Tools and Applications, vol. 48, no. 3, pp. 381-409, 2010). In FIG. 10, the performance of H.264/AVC Intra and H.264/AVC No Motion is represented. The assessed H.264/AVC codecs exhibit higher encoding complexity than the proposed DVC solution. The results show that, similarly to DISCOVER, the proposed scheme significantly outperforms H.264/AVC Intra for low motion sequences, e.g., Silent. Contrary to the other DVC codecs, though, the proposed scheme manages to partially outperform H.264/AVC Intra and No Motion in Foreman.

To appraise its applicability in wireless capsule endoscopy, the proposed codec has been evaluated using capsule endoscopic video material. Motion JPEG has been set as benchmark, since this codec is used in current capsule endoscopes. For a fair comparison, Motion JPEG has also been used to code the key frames and the WZ hash in the proposed codec equipped with the invention. The results shown in FIG. 11(a), point out that the proposed DVC yields notable compression improvements against Motion JPEG. New trends in capsule endoscopy aim at increasing the frame rates and resolutions. Therefore, to explore its capability under these conditions, the proposed DVC codec is evaluated using conventional endoscopic video sequences. In this experiment, the embodiment employs H.264/AVC Intra to code the key frames and the hash. The results in FIG. 11(b) demonstrate that the embodiment outperforms both H.264/AVC Intra and the implementation of the DISCOVER codec (namely the TDWZ codec).

While the invention has been illustrated and described in detail in the drawings and foregoing description, such illustration and description are to be considered illustrative or exemplary and not restrictive. The foregoing description details certain embodiments of the invention. It will be appreciated, however, that no matter how detailed the foregoing appears in text, the invention may be practiced in many ways. The invention is not limited to the disclosed embodiments.

The presented invention can also be applied in channel coding, distributed source coding, denoising and watermarking applications. Potential fields of application include sensor networks, capsule endoscopy, distributed image and video coding, compression of light fields, compression of large camera arrays, digital watermarking, wireless communications, multimedia communications, distributed joint source channel coding, forward lossy/lossless error protection, signal denoising, multi-view video coding without requiring inter-camera communication, flexible video decoding and flexible distribution of complexity.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1-14. (canceled)

15. A method for estimating at a decoder statistical correlation between a first signal available to said decoder and a second signal correlated with said first signal, said second signal encoded by an encoder and unavailable at said decoder, said first and said second signal each being represented by a plurality of bit planes, the method comprising the steps of:
deriving an estimate of said statistical correlation based on said first signal and at least one previously decoded bit plane of said second signal; and
performing decoding of a subsequent bit plane of said second signal (X) based on said estimate obtained in the previous step.

16. The method for estimating as in claim 15, wherein said steps of deriving said estimate and performing decoding are executed iteratively.

17. The method for estimating as in claim 15, comprising the step of reconstructing said second signal at said decoder.

18. The method for estimating as in claim 17, wherein said step of reconstructing is performed after decoding all bit planes of said second signal.

19. The method for estimating as in claim 15, comprising the step of transmitting to said decoder a losslessly compressed first bit plane of said second signal.

20. The method for estimating as in claim 15, wherein a first decoded bit plane of said second signal is derived from an initial estimate based on a previously decoded block of data.

21. The method for estimating as in claim 15, wherein the dissimilarity between said first signal and said second signal is caused by communication channel errors and/or prediction errors.

22. The method for estimating as in claim 15, wherein statistical properties of said first signal and said second signal vary per block of samples.

23. The method for estimating as in claim 15, wherein said statistical correlation is represented by an additive noise channel model X=Y+N, whereby Y denotes said first signal, X said second signal and N a channel noise signal.

24. The method for estimating as in claim 23, wherein said channel noise signal is statistically dependent on said first signal.

25. The method for estimating as in claim 15, wherein said first and said second signal represent samples of video.

26. Use of the method for estimating as in claim 15 in video capsule endoscopy.

27. A computer program, executable on a programmable device containing instructions, which, when executed, in accordance with the method of claim 15.

28. A decoder adapted for estimating statistical correlation between a first signal available at said decoder and a second signal, said second signal being correlated with said first signal and unavailable at said decoder, whereby said first and said second signal are each represented by a plurality of bit planes, said decoder comprising processing means arranged for deriving an estimate of said statistical correlation based on said first signal and on at least one previously decoded bit plane of said second signal, said decoder further being arranged for decoding a subsequent bit plane of said second signal based on said estimate derived by said processing means.
